(19) United States
(12) Patent Application Publication
(10) Pub. No.: US 2007/0075978 A1
(43) Pub. Date: Apr. 5, 2007

(54) Adaptive input method for touch screen

(75) Inventor: Kuo-Hua Chung, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/260,702

(22) Filed: Oct. 27, 2005

(30) Foreign Application Priority Data
Sep. 30, 2005 (TW) 094134223

(51) Int. Cl. G09G 5/00

(52) U.S. Cl. 345/173

(57) ABSTRACT

An adaptive input method for a touch screen is provided. A keyboard frame having a plurality of possible keys is on the touch screen, wherein the contents of the possible keys are determined according to the type of a preceding data inputted via the keyboard frame. A character is displayed on the touch screen when a corresponding handwriting is written on the keyboard frame.

### FIELD OF THE INVENTION

The present invention relates to an input method for a touch screen, and more particularly to an adaptive input method for a touch screen.

### BACKGROUND OF THE INVENTION

Touch screens are widely used in handheld electronic devices, for example mobile phones and personal digital assistants (PDAs), as the interfaces for inputting data therevia.

Conventionally, there are two common methods for inputting data via the touch screen. The first input method uses a stylus to touch virtual keys. The second method is a handwriting input method.

The operating principle of inputting data by touching virtual keys will be illustrated with reference to FIG. 1A. Referring to FIG. 1A, a schematic view of a conventional touch screen is shown. The touch screen 100 includes a virtual keyboard 101, which has a plurality of virtual keys 1011. The virtual keys 1011 include alphabetical keys, numeric keys, symbolic keys, function keys, etc. For example, by using a stylus to touch the virtual keys 1011, the designated letters in the English alphabet, symbols or functions are inputted via the touch screen 100.

As known, the inputting speed of using the virtual keyboard is much lower than that of using a real keyboard. By using the real keyboard, the ten fingers of the user are responsible for pressing respective specified keys. Even when the current key (e.g. the letter P) and the next key (e.g. the letter Q) to be pressed are far from each other, the user needs not shift one finger by a long distance. On the contrary, since only one stylus is used to touch the virtual keyboard, the time interval between two successive touch operations is relatively long. If the current key and the next key to be touched are far from each other, the user should shift the stylus by a larger distance. Consequently, the inputting speed of using the virtual keyboard is usually undesirable and the possibility of inputting wrong keys is increased.

Referring to FIG. 1B, a handwriting input interface of a touch screen is shown. Users may enter a text, e.g. a letter “a”, by writing on the handwriting input interface 102 of the touch screen. With handwriting recognition, users can easily add entries to their handheld electronic devices.

Generally, these two input methods are applicable to input data via touch screens. However, either the virtual keyboard input mode or the handwriting recognition input mode can be used at a time. For handwriting input, the operating mode of the touch screen should be switched from the virtual keyboard input mode to the handwriting recognition input mode. Similarly, after the handwriting recognition input mode is switched to the virtual keyboard input mode, the user may begin to input data by touching virtual keys.

In views of the above-described disadvantages, the applicant keeps on carving unflaggingly to develop an adaptive input method for a touch screen according to the present invention through wholehearted experience and research.

### SUMMARY OF THE INVENTION

It is an object of the present invention to provide an adaptive input method for a touch screen to increase the inputting efficiency, flexibility and convenience for the touch screen.

In accordance with an aspect of the present invention, there is provided an adaptive input method for a touch screen. A keyboard frame having a plurality of possible keys is on the touch screen, wherein the contents of the possible keys are determined according to the type of a preceding data inputted via the keyboard frame. A character is displayed on the touch screen when a corresponding handwriting is written on the keyboard frame.

In an embodiment, the keyboard frame includes an alphabetical keyboard frame for displaying plural lowercase letters, a numeric keyboard frame for displaying plural numbers or a symbolic virtual keyboard for indicating punctuation marks.

In accordance with another aspect of the present invention, there is provided a handheld electronic device. The handheld electronic device comprises a touch screen and an input control unit. The touch screen is used for inputting data therevia. The input control unit is used for displaying a keyboard frame having a plurality of possible keys on the touch screen and displaying a character on the touch screen when a corresponding handwriting is written on the keyboard frame. The contents of the possible keys are determined according to the type of a preceding data inputted via the keyboard frame, and

Preferably, the handheld electronic device is a mobile phone.

Preferably, the handheld electronic device is a personal digital assistant (PDA).

The above objects and advantages of the present invention will become more readily apparent to those ordinarily skilled in the art after reviewing the following detailed description and accompanying drawings, in which:

### BRIEF DESCRIPTION OF THE DRAWINGS

FIGS. 1A and 1B are schematic views of a conventional touch screen;

FIG. 2 is a schematic view of a handheld electronic device with a touch screen according to a preferred embodiment of the present invention;

FIGS. 3A-3C schematically illustrate three types of keyboard frames used in the present invention; and

FIGS. 4˜27 are schematic views of the touch screen illustrating the steps for inputting an English sentence according to the conventional adaptive input method and the adaptive input method of the present invention.

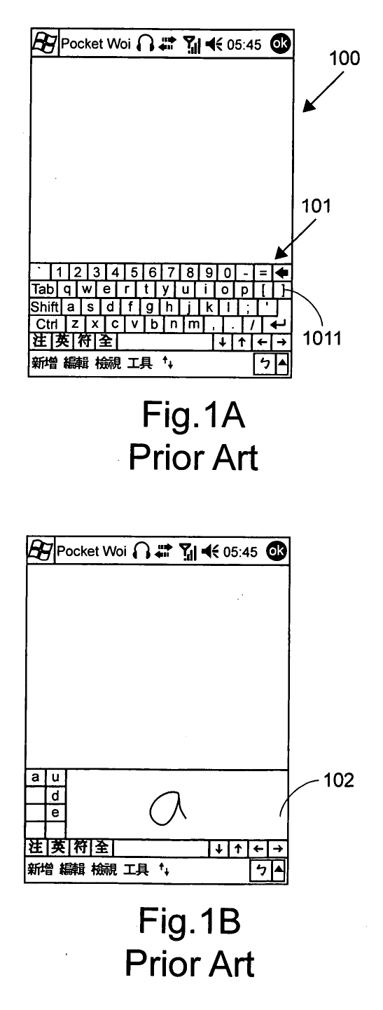

### DETAILED DESCRIPTION OF THE PREFERRED EMBODIMENT

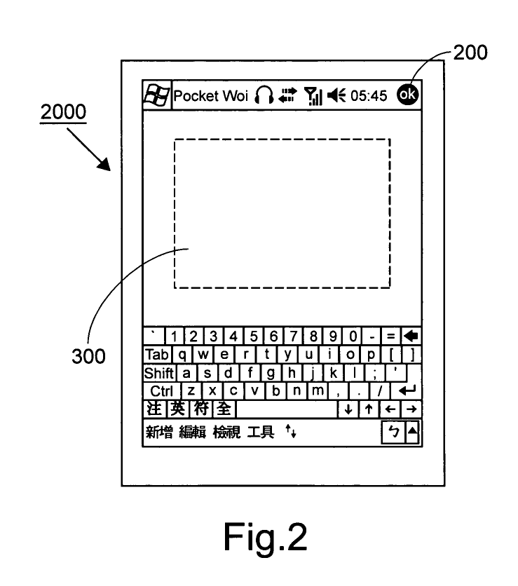

Referring to FIG. 2, a schematic view of a handheld electronic device with a touch screen according to a preferred embodiment of the present invention is illustrated. An example of the handheld electronic device 2000 is a mobile phone or a personal digital assistant (PDA). The handheld electronic device 2000 comprises a touch screen 200 and an input control unit 300 mounted within the main body thereof. The input control unit 300 controls implementation of the adaptive input method of the present invention.

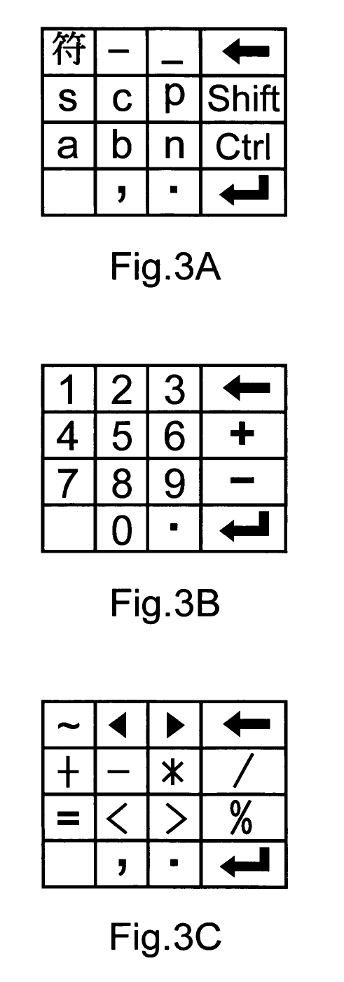

Please refer to FIGS. 3A-3C, which schematically illustrate three types of keyboard frames used in the present invention. These keyboard frames are generated according to the preceding data. The keyboard frames shown in FIGS. 3A, 3B and 3C indicate alphabetical, numeric and symbolic keyboard frames, respectively.

Take the English alphabetical system for example. A single character is composed of one or more letters. According to a statistic result relating to 26,000 single characters in an English dictionary, five letters with the highest possibilities of occurrences following a specified letter at a specified position are reported in the following table.

| | | Five letters |
|---|---|---|
| | Specified | with the highest possibilities of |
| Position | Letter | occurrences following a specified letter |
| 1 | p | r, a, e, o, i |
| 1 | i | n, m, r, s, d |
| 1 | y | o, a, e, u, a |
| 1 | o | r, b, p, c, s |
| 2 | e | r, n, l, a, s |
| 2 | l | a, o, e, u, i |
| 2 | r | a, o, e, i, u |
| 2 | s | t, s, y, c, p |
| 3 | a | n, r, t, d, c |
| 3 | d | i, e, d, r, a |
| 3 | i | n, t, l, s, m |
| 4 | m | i, a, e, o, p |
| 4 | r | e, i, o, a, t |
| 5 | a | n, r, t, l, c |
| 5 | s | t, i, e, o, h |
| 6 | x | i, y, t, e |

From this statistic table with respect to the 26,000 single characters, the letters “p”, “i”, “y” and “o” have the highest possibilities of occurrences in the first position of the single characters. Whereas, the letters “e”, “l”, “r” and “s” have the highest possibilities of occurrences in the second position of the single characters. The rest may be deduced by analogy. On the other hand, the five letters with the highest possibilities of occurrences following the letter “p” are “r”, “a”, “e”, “o”, “i” if the letter “p” is located in the first position. Whereas, if the letter “i” is located in the first position, the five letters with the highest possibilities of occurrences following the letter “i” are “n”, “m”, “r”, “s” and “d”. The rest may be deduced by analogy. This statistic table is recorded in the handheld electronic device.

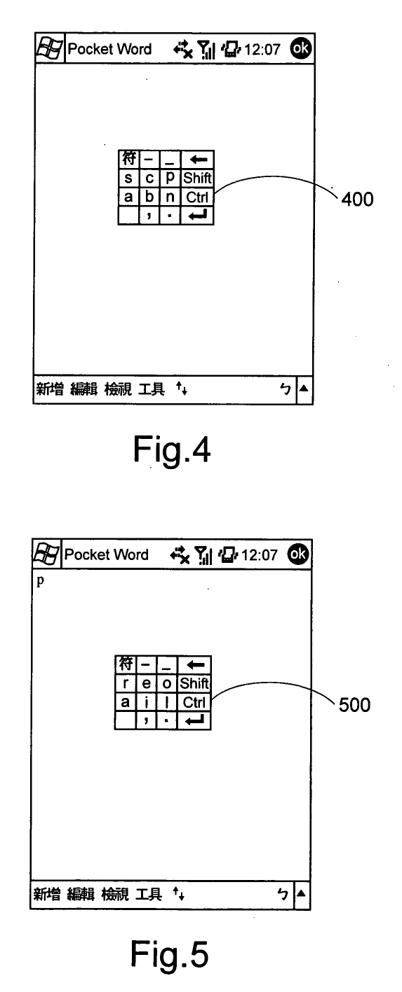

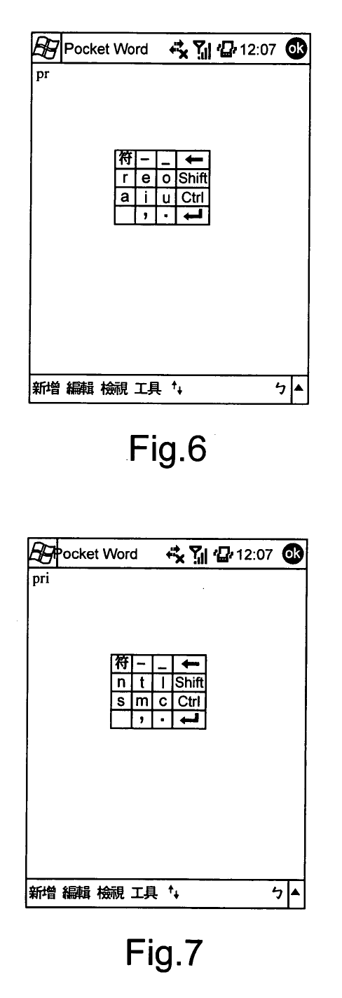

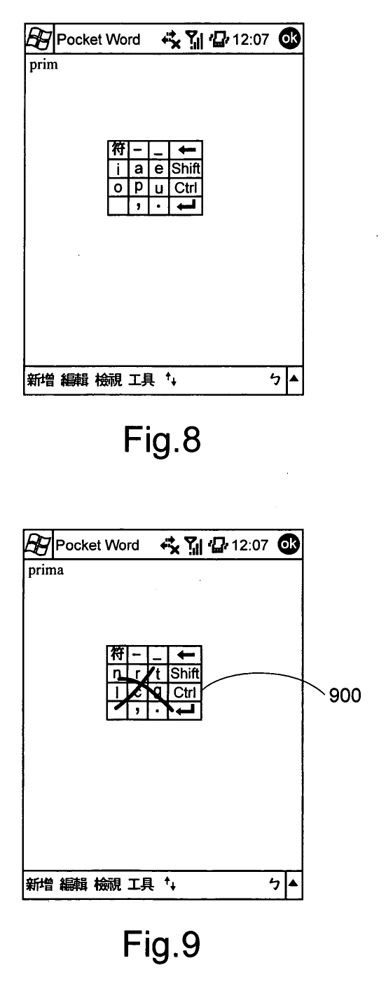

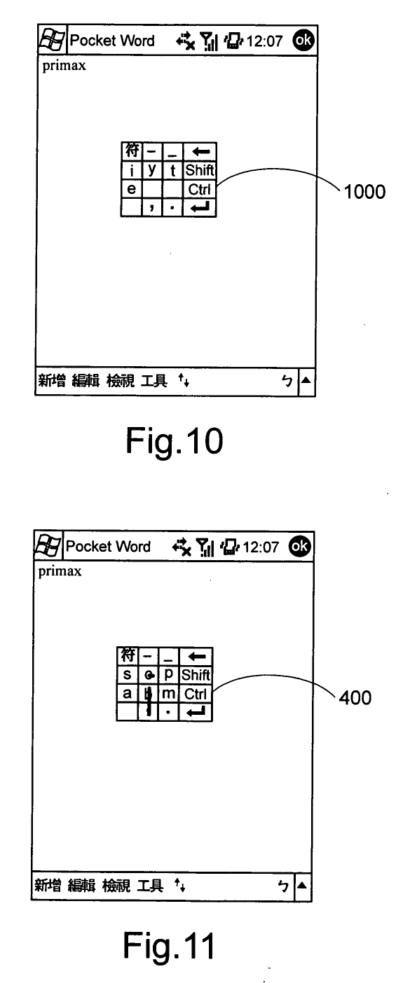

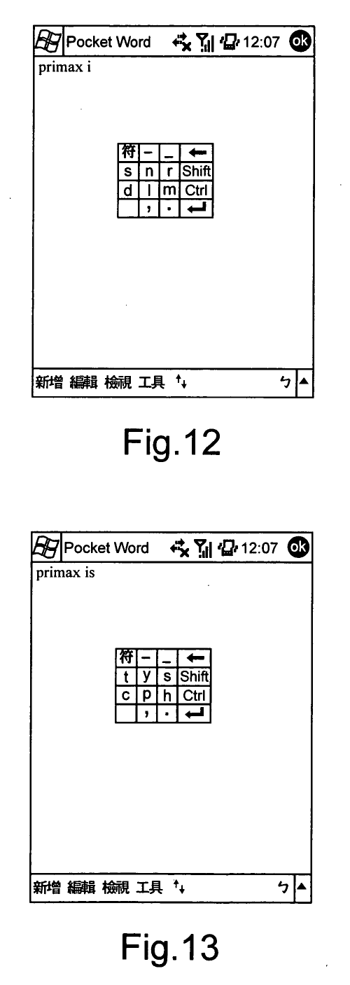

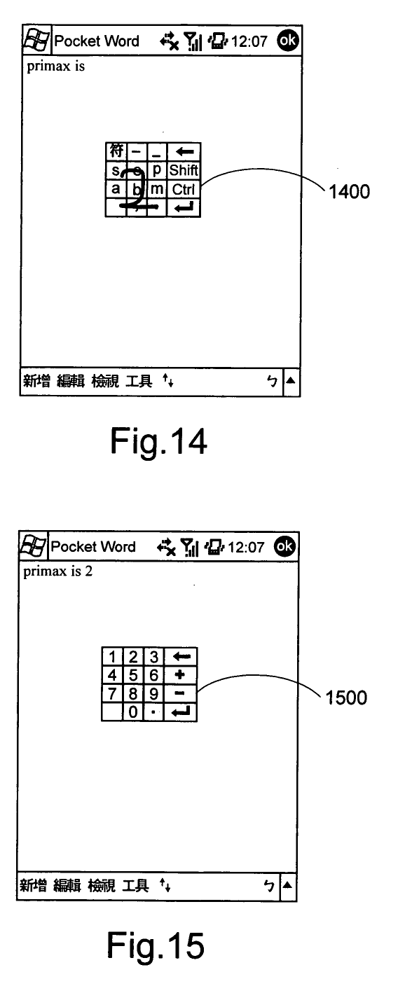

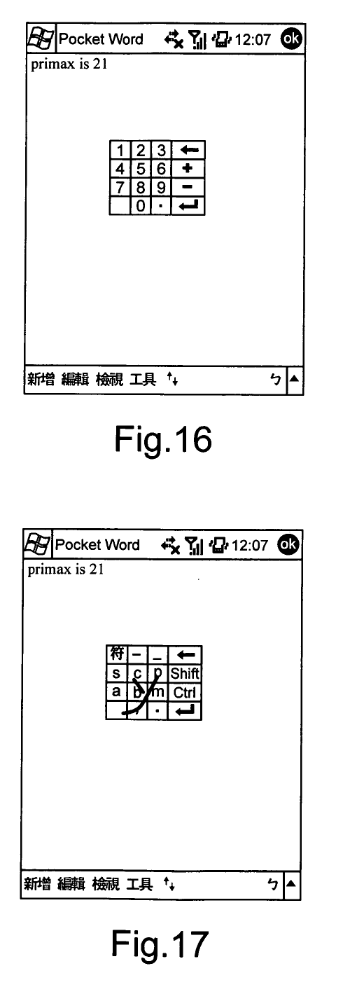

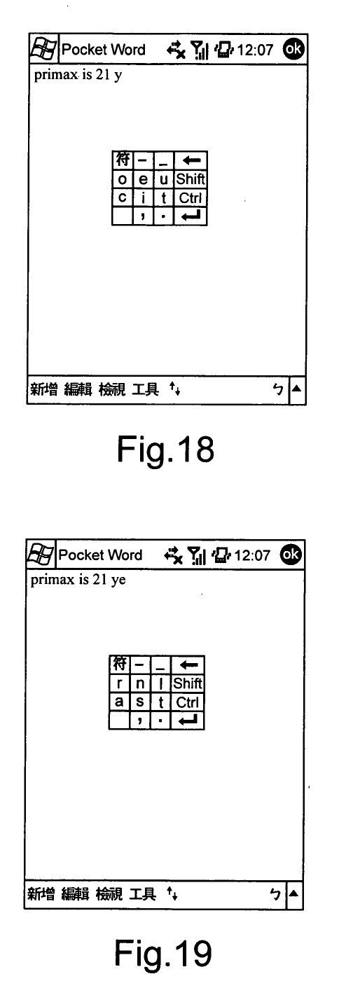

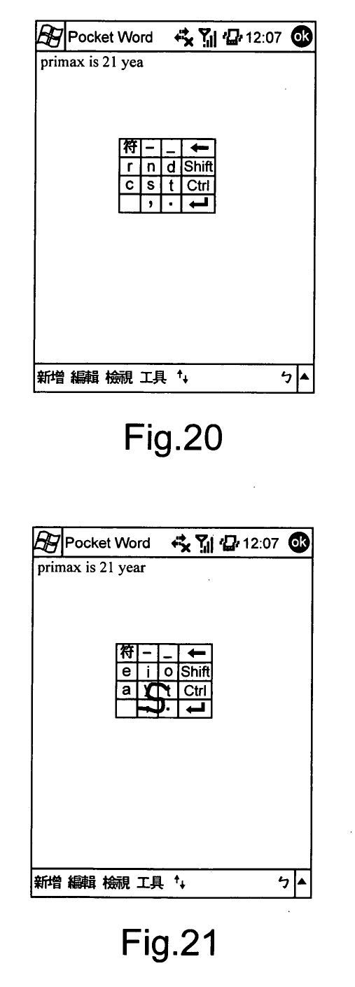

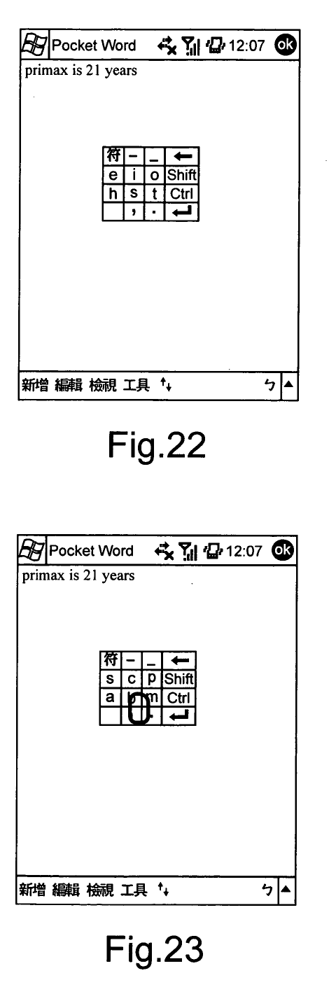

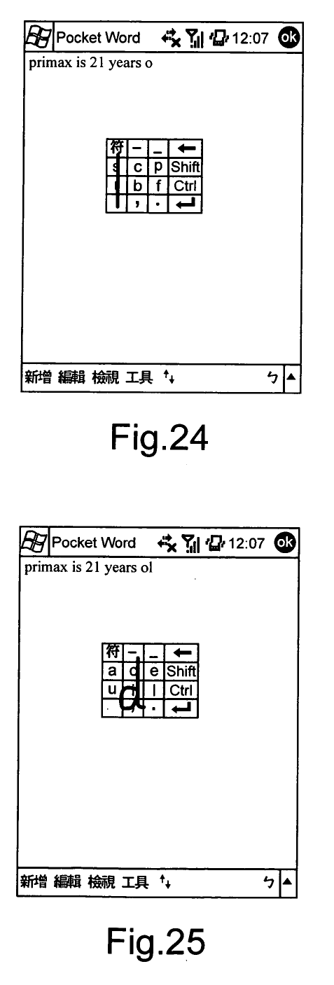

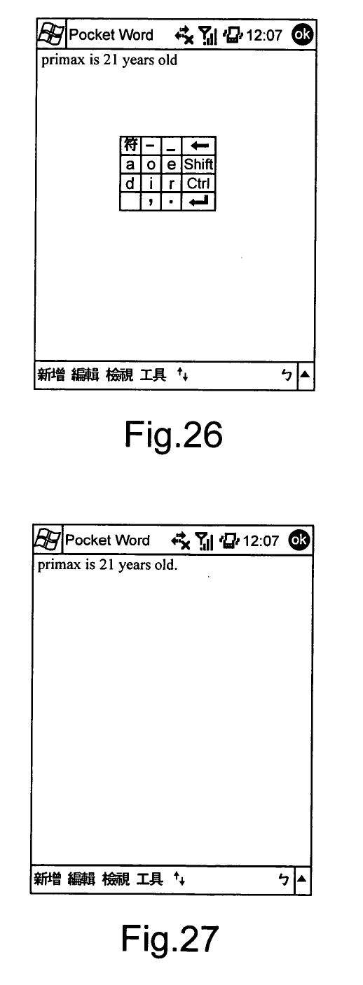

Hereinafter, an embodiment of an adaptive input method according to the present invention will be illustrated with reference to FIGS. 4˜27, in which a sentence “Primax is 21 years old.” will be inputted into the handheld electronic device via the touch screen.

Please refer to FIG. 4. In the beginning, an alphabetical keyboard frame 400 is displayed on the touch screen. The letters shown on the alphabetical keyboard frame 400 have the highest possibilities of occurrences in the first position of a sentence according to statistic results.

As shown in FIG. 4, in the sentence “Primax is 21 years old.”, the first letter to be inputted is “p”.

After the letter “p” is inputted, the input control unit 300 enables another alphabetical keyboard frame 500 to be displayed and overlie on the touch screen, as is shown in FIG. 5. The alphabetical keyboard frame 500 displays nine possible virtual keys including the five letters with the highest possibilities of occurrences following the letter “p” (i.e. “r”, “a”, “e”, “o”, “i”), punctuation marks “,” and “.”, and a space key. Since some highly possible letters to be inputted are displayed on the alphabetical keyboard frame 500 in response to the action of touching the letter “p”, the user can select the next letter “r” without difficulty because the distance for moving the stylus is largely reduced. In contrast, for a purpose of touching the letter “r”, according to the conventional input method, a stylus should be moved from the virtual key p to the virtual key r displayed on the conventional virtual keyboard, which means a long relative distance.

Please refer to FIGS. 6-8. The letters “i”, “m” and “a” following the letter “r” are successively inputted according to the adaptive input methods similar to those described in FIG. 5, and are not to be redundantly described herein.

Referring to FIG. 9, the next letter to be inputted is “x”. According to the present invention, after the letter “a” is inputted, the input control unit 300 enables another alphabetical keyboard frame 900 to be displayed on the touch screen, as is shown in FIG. 9. The alphabetical keyboard frame 900 displays nine possible keys including the five letters with the highest possibilities of occurrences following the letter “a” (i.e. “n”, “r”, “t”, “l”, “c”), two punctuation marks “,” and “.”, and a space key. Since the letter “x” is not included in these highly possible letters displayed on the alphabetical keyboard frame 900, the letter “x” may be handwritten on the alphabetical keyboard frame 900 by using the stylus.

Referring to FIG. 10, after the letter “x” is inputted, the input control unit 300 enables another alphabetical keyboard frame 1000 to be displayed on the touch screen. The alphabetical keyboard frame 1000 displays nine possible keys including the four letters with the highest possibilities of occurrences following the letter “a” (i.e. “i”, “y”, “t”, “e”), punctuation marks “,” and “.”, and three space keys. Since “x” is the last letter of the character “Primax”, the user can directly select a space key on the alphabetical keyboard frame 1000 in order to input the second character.

Referring to FIG. 11, the next letter to be inputted is “i”. Since the statistic data associated with the highest possibilities of occurrences following the space key is absent, the alphabetical keyboard frame 400 would be displayed on the touch screen again. Unfortunately, since the letter “i” is not included in these highly possible letters displayed on the alphabetical keyboard frame 400, the letter “i” may be handwritten on the alphabetical keyboard frame 400 by using the stylus.

Please refer to FIGS. 12˜13. The letter “s” and the space key following the letter “i” are successively inputted to the touch screen according to the adaptive input methods similar to those described above, and are not to be redundantly described herein.

Referring to FIG. 14, the next text to be inputted is “2”. Likewise, since the statistic data associated with the highest possibilities of occurrences following the space key are absent, another alphabetical keyboard frame 1400 (which is identical to the frame 400) would be displayed on the touch screen. The number “2” is not included in the alphabetical keyboard frame 1400, and thus may be handwritten on the alphabetical keyboard frame 1400 by using the stylus.

Referring to FIG. 15, the next number to be inputted is “1”. According to the present invention, after the number “2” is inputted, the input control unit 300 enables a numeric keyboard frame 1500 to be displayed on the touch screen. Statistically, the object with the highest possibility of occurrence following a specified number is also a number. As a result, the numeric keyboard frame 1500 displays twelve possible keys including the numbers 0˜9, a punctuation marks “.” and a space key. Under this circumstance, the user can select the next number “1” from the numeric keyboard frame 1500.

Please refer to FIG. 16. Since “1” is the last number of the character “21”, the user can directly select a space key on the numeric keyboard frame 1500 in order to input the next character.

Please refer to FIGS. 17˜27. The other characters “years old.” are successively inputted according to the adaptive input methods similar to those described above, and are not to be redundantly described herein.

It is to be noted that the above descriptions of preferred embodiments of this invention are presented herein for purpose of illustration and description only. It is not intended to be exhaustive or to be limited to the precise form disclosed. The number and type of virtual keys to be displayed on the alphabetical, numeric or symbolic virtual keyboards, for example the alphabetical keys, numeric keys, symbolic keys or function keys, may be designated according to the user's requirement. Moreover, for increasing the recognition rate of handwriting input, only the lowercase letters a˜z and the numbers 0˜9 are recognized according to the present method.

From the above description, the adaptive input method of the present invention is advantageous for facilitating a user to promptly input the virtual keys displayed on three types of keyboard frames without the switching from the virtual keyboard input mode to the handwriting recognition input mode. As a consequence, the inputting efficiency for the touch screen is increased and the possibility of inputting wrong keys is minimized.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications-and similar structures.

What is claimed is:

1. An adaptive input method for a touch screen, comprising steps of:
displaying a keyboard frame having a plurality of possible keys on said touch screen, wherein the contents of said possible keys are determined according to the type of a preceding data inputted via said keyboard frame, and
displaying a character on said touch screen when a corresponding handwriting is written on said keyboard frame.

2. The adaptive input method according to claim 1 wherein said keyboard frame includes an alphabetical keyboard frame for displaying plural lowercase letters, a numeric keyboard frame for displaying plural numbers or a symbolic virtual keyboard for indicating punctuation marks.

3. A handheld electronic device comprising:
a touch screen for inputting data therevia; and
an input control unit for displaying a keyboard frame having a plurality of possible keys on said touch screen, wherein the contents of said possible keys are determined according to the type of a preceding data inputted via said keyboard frame, and displaying a character on said touch screen when a corresponding handwriting is written on said keyboard frame.

4. The handheld electronic device according to claim 3 wherein said handheld electronic device is a mobile phone.

5. The handheld electronic device according to claim 3 wherein said handheld electronic device is a personal digital assistant (PDA).
